(19) United States
(12) Patent Application Publication
(10) Pub. No.: US 2016/0262208 A1
(43) Pub. Date: Sep. 8, 2016

(54) FIXING METHOD OF CARBON FIBER BUNDLE AND FLEXIBLE GAS PERMEABLE ELECTRIC HEATING STRUCTURE MADE THEREOF

(71) Applicant: JIA-CHENG HSIEH, NEW TAIPEI CITY (TW)

(72) Inventor: JIA-CHENG HSIEH, NEW TAIPEI CITY (TW)

(21) Appl. No.: 14/640,297

(22) Filed: Mar. 6, 2015

(51) Int. Cl. H05B 3/34; H05B 3/08; A41D 13/005; H05B 3/16; D05B 1/02; H05B 3/03; H05B 3/14

(52) U.S. Cl. CPC H05B 3/34; H05B 3/03; H05B 3/08; H05B 3/145; H05B 3/16; D05B 1/02; A41D 13/0051

(57) ABSTRACT

A fixing method of carbon fiber bundle and a flexible gas permeable electric heating structure made thereof. The fixing method includes steps of: making multiple carbon fiber bundles each composed of at least two carbon fiber yarns intersect and touch each other to form a carbon fiber mesh as a meshed electro-conductive circuit; laying two load electrodes on the carbon fiber mesh in two different positions; and using a smocking machine to form multiple machine sewing threads for sewing the carbon fiber mesh with the meshed electro-conductive circuit and the two load electrodes at least one face of a flexible substrate to form the flexible gas permeable electric heating structure. The flexible gas permeable electric heating structure is advantageous in that it is uneasy to break, gas permeable and durable and a user can comfortably wear the flexible gas permeable electric heating structure.

### BACKGROUND OF THE INVENTION

1. Field of the Invention

The present invention relates generally to a fixing method of carbon fiber bundle and a flexible gas permeable electric heating structure made thereof. The flexible gas permeable electric heating structure is advantageous in that it is uneasy to break, gas permeable and durable and a user can comfortably wear the flexible gas permeable electric heating structure.

2. Description Of The Prior Art

In order to heat a fluid or an article or keep a human body warm, various electric heating structures have been developed for raising the temperature or keeping the temperature higher than that of the environment, for example, electric heating blanket, electric heating wear, electric heating footmuff and electric heating quilt. All these electric heating products are used in winter to keep human body warm. The electric heating product is generally composed of two blankets or cotton layers and a thermal resistor circuit of one or more sets of electric heating components disposed between the blankets or cotton layers. When powered on, the electric heating components convert electric energy into heat to raise the surface temperature of the electric heating blanket, electric heating wear, electric heating footmuff, electric heating quilt or the like to be higher than the temperature of the environment. In this case, a user covered by the electric heating blanket or the electric heating quilt or wearing the electric heating wear or the electric heating footmuff can keep warm.

Various conventional electric heating products, such as heating wear structure with low-voltage heating sheets, electric heating implement with warm-keeping function, electric heating seat cushion and electric heating blanket, all employ electric heating plates, electric heating wires or electric heating films as electric heating components. These electric heating components are all metal components, which are likely to (nondurably) break under bending or folding in use. Therefore, the above electric heating products can be hardly lastingly used. Moreover, these metal-made heating components are gas impermeable. As a result, when a user wears or is covered by these products, the user will feel uncomfortable.

### SUMMARY OF THE INVENTION

It is therefore a primary object of the present invention to provide a fixing method of carbon fiber bundle and a flexible gas permeable electric heating structure made thereof to solve the above problems of uncomfortableness caused by gas impermeability and nondurability. In the fixing method, multiple carbon fiber bundles each composed of at least two carbon fiber yarns are woven and sown on a flexible substrate. The carbon fiber bundles intersect and touch each other to form a meshed electro-conductive circuit. The flexible gas permeable electric heating structure of the present invention can solve the problem of the conventional electric heating products with electric heating plates, electric heating wires, carbon fiber plates or alloy fiber plates as heating components that these electric heating components are likely to break under bending or folding in use. Also, the problem of uncomfortableness caused by gas impermeability can be solved. In other words, the flexible gas permeable electric heating structure of the present invention is advantageous in that it is uneasy to break, gas permeable and durable and a user can comfortably wear the flexible gas permeable electric heating structure.

To achieve the above and other objects, the fixing method of carbon fiber bundle of the present invention includes steps of: making multiple carbon fiber bundles each composed of at least two carbon fiber yarns intersect and touch each other to form a carbon fiber mesh as a meshed electro-conductive circuit; laying two load electrodes on the carbon fiber mesh in two different positions; and using a smocking machine to form multiple machine sewing threads for sewing the carbon fiber mesh with the meshed electro-conductive circuit and the two load electrodes at least one face of a flexible substrate to form the flexible gas permeable electric heating structure.

The flexible gas permeable electric heating structure of the present invention includes: a flexible substrate; a carbon fiber mesh woven from multiple carbon fiber bundles each including at least two carbon fiber yarns, the carbon fiber bundles intersecting and touching each other to form a meshed electro-conductive circuit; multiple machine sewing threads for sewing the carbon fiber mesh with the meshed electro-conductive circuit on at least one face of the flexible substrate; and two load electrodes laid on the carbon fiber mesh in two different positions for powering the carbon fiber mesh.

The above flexible gas permeable electric heating structure further includes: a power supply connected with the two load electrodes; an overheating protection structure connected between the power supply and the load electrodes; and a switch connected between the power supply and the load electrodes.

In the above flexible gas permeable electric heating structure, the two load electrodes are woven from multiple low-resistivity metal conductive wires. The two load electrodes are sown on the carbon fiber mesh in two different positions by multiple machine sewing threads for powering the carbon fiber mesh.

In the above flexible gas permeable electric heating structure, the carbon fiber mesh, multiple machine sewing threads and the two load electrodes woven from the metal conductive wires are all sown by the smocking machine at one time. The working process is simplified and the sewing operation is completed at one time to save labor, save time and save cost.

The flexible gas permeable electric heating structure of the present invention can be made in any applicable form such as the form of a plate, a cup, a barrel, etc. In addition, by means of an attachment structure such as hook-and-loop fasteners, the flexible gas permeable electric heating structure can be disposed on an article such as a clothes, a pants, a glove, a blanket, a shoe, a seat cushion, a couch, a cup, a thermos, an electric heating blanket, a foot-warmer, a heating joint wrap, a heating waist protector, etc. The carbon fiber bundles of the electric heating structure can fully provide the advantages of softness, anti-folding, small volume, lightweight, high electro-conductivity, high-temperature-resistance and anti-corrosion for these products.

The flexible gas permeable electric heating structure of the present invention is advantageous in that it is uneasy to break, gas permeable and durable and a user can comfortably wear the flexible gas permeable electric heating structure.

The present invention can be best understood through the following description and accompanying drawings, wherein:

### BRIEF DESCRIPTION OF THE DRAWINGS

FIG. 1 is a plane view of the present invention;

FIG. 2 is a perspective view of the present invention;

FIG. 3 is a perspective view of the present invention, showing that the present invention is applied to a clothes to keep warm;

and

FIG. 4 is a perspective view of the present invention, showing that the present invention is applied to a thermos.

### DETAILED DESCRIPTION OF THE PREFERRED EMBODIMENTS

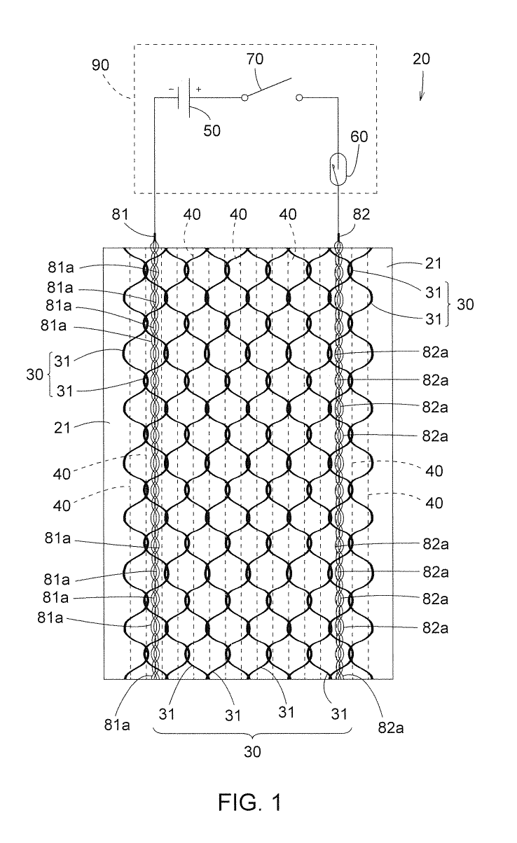

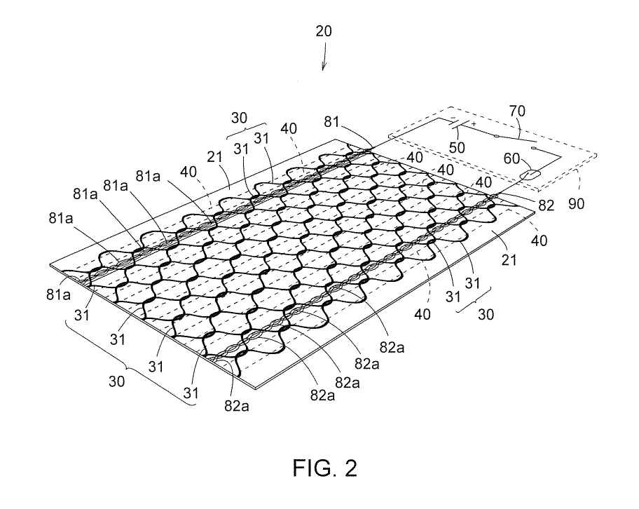

Please refer to FIGS. 1 and 2. In the fixing method of carbon fiber bundle of the present invention, multiple carbon fiber bundles 31 each composed of at least two carbon fiber yarns intersect and touch each other to form a carbon fiber mesh 30 as a meshed electro-conductive circuit. Two load electrodes 81, 82 are laid on the carbon fiber mesh 30 in two different positions. A smocking machine is used to form multiple machine sewing threads 40 for sewing the carbon fiber mesh 30 with the meshed electro-conductive circuit and the two load electrodes 81, 82 on at least one face of a flexible substrate 21 to form a flexible gas permeable electric heating structure 20.

Please refer to FIGS. 1 and 2. The flexible gas permeable electric heating structure 20 of the present invention includes a flexible substrate 21 and a carbon fiber mesh 30. The carbon fiber mesh 30 is woven from multiple carbon fiber bundles 31 each including at least two carbon fiber yarns, (for example, 3000˜8000 carbon fiber yarns). By means of a smocking machine, the carbon fiber bundles 31 intersect and touch each other to form a meshed electro-conductive circuit. The flexible gas permeable electric heating structure 20 of the present invention further includes multiple machine sewing threads 40 formed by the smocking machine for sewing the carbon fiber mesh 30 with the meshed electro-conductive circuit on at least one face of the flexible substrate 21. The flexible gas permeable electric heating structure 20 of the present invention further includes two load electrodes 81, 82 laid on the carbon fiber mesh 30 in two different positions for powering the carbon fiber mesh 30.

Please refer to FIGS. 1 and 2. The flexible gas permeable electric heating structure 20 of the present invention further includes a power supply 50 connected with the two load electrodes 81, 82, an overheating protection structure 60 connected between the power supply 50 and the load electrodes 81, 82 and a switch 70 connected between the power supply 50 and the load electrodes 81, 82.

Please refer to FIGS. 1 and 2. In the flexible gas permeable electric heating structure 20 of the present invention, the overheating protection structure 60 is generally a thermal protector made of bimetal and solid silver contact. The overheating protection structure 60 provides multistage temperature controls, for example, low temperature (15° C.˜25° C. overheating protection), mediate temperature (25° C.˜80° C.) and high temperature (80° C.˜95° C.) controls to satisfy different requirements in use.

Please refer to FIGS. 1 and 2. In the flexible gas permeable electric heating structure 20 of the present invention, the two load electrodes 81, 82 are woven from multiple low-resistivity metal conductive wires 81a, 82a (such as silver-coated copper wires). The two load electrodes 81, 82 are sown on the carbon fiber mesh 30 in two different positions by multiple machine sewing threads 40 for powering the carbon fiber mesh 30.

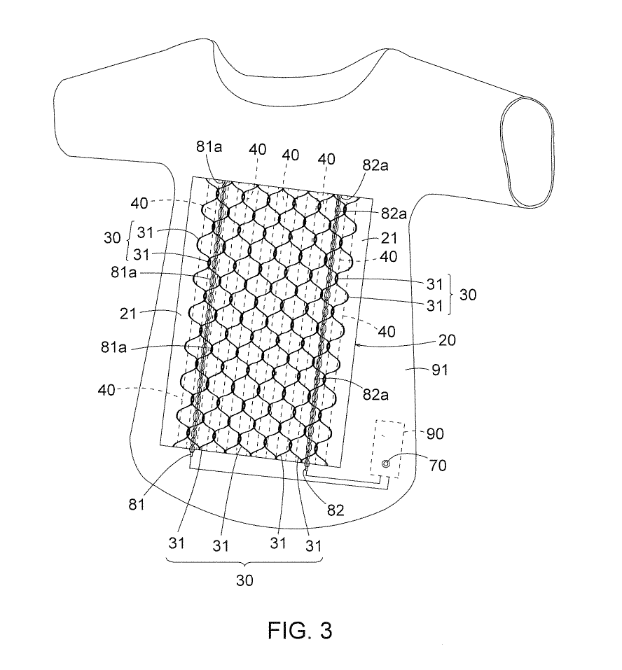

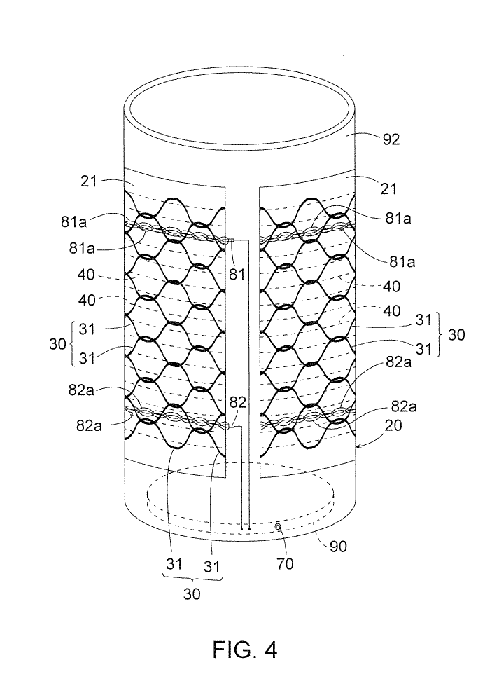

Please refer to FIGS. 1 to 4. In the flexible gas permeable electric heating structure 20 of the present invention, the carbon fiber mesh 30 is uniformly sown on the flexible substrate 21 so as to uniformly transfer heat. Accordingly, the temperature is uniformly distributed over every part of the flexible substrate 21.

The carbon fiber mesh 30 of the present invention is harmless to human body and safer than a common electric wire or thermal metal plate.

The two load electrodes 81, 82 of the present invention are woven from multiple low-resistivity metal conductive wires 81a, 82a (such as silver-coated copper wires). The two load electrodes 81, 82 are able to quickly raise the temperature of the carbon fiber mesh 30 to shorten the warming time.

The power supply 50 of the present invention can be powered by a battery, a mobile power supply, car charger, USB socket or common power socket. The cost for the electricity is low and it is quite convenient to use such power supply.

The flexible gas permeable electric heating structure 20 of the present invention is woven from the carbon fiber bundles 31 so that the flexible gas permeable electric heating structure 20 is uneasy to break. Moreover, the carbon fiber bundles 31 are woven to intersect each other and form a mesh structure so that the flexible gas permeable electric heating structure 20 of the present invention is gas permeable and durable and a user can comfortably wear the flexible gas permeable electric heating structure 20.

The above embodiments are only used to illustrate the present invention, not intended to limit the scope thereof. Many modifications of the above embodiments can be made without departing from the spirit of the present invention.

What is claimed is:

1. A fixing method of carbon fiber bundle, comprising steps of:
making multiple carbon fiber bundles each composed of at least two carbon fiber yarns intersect and touch each other to form a carbon fiber mesh as a meshed electro-conductive circuit; laying two load electrodes on the carbon fiber mesh in two different positions; and
using a smocking machine to form multiple machine sewing threads for sewing the carbon fiber mesh with the meshed electro-conductive circuit and the two load electrodes at least one face of a flexible substrate to form a flexible gas permeable electric heating structure.

2. A flexible gas permeable electric heating structure comprising:
a flexible substrate;
a carbon fiber mesh woven from multiple carbon fiber bundles each including at least two carbon fiber yarns, the carbon fiber bundles intersecting and touching each other to form a meshed electro-conductive circuit;
multiple machine sewing threads for sewing the carbon fiber mesh with the meshed electro-conductive circuit on at least one face of the flexible substrate; and
two load electrodes laid on the carbon fiber mesh in two different positions for powering the carbon fiber mesh.

3. The flexible gas permeable electric heating structure as claimed in claim 2, further comprising:
a power supply connected with the two load electrodes;
an overheating protection structure connected between the power supply and the load electrodes; and
a switch connected between the power supply and the load electrodes.

4. The flexible gas permeable electric heating structure as claimed in claim 2, wherein the two load electrodes are woven from multiple low-resistivity metal conductive wires, the two load electrodes being sown on the carbon fiber mesh in two different positions by multiple machine sewing threads for powering the carbon fiber mesh.
